(19) United States
(12) Patent Application Publication
(10) Pub. No.: US 2022/0281270 A1
(43) Pub. Date: Sep. 8, 2022

(54) TIRE INSTALLATION AND REMOVAL TOOL AND METHOD

(71) Applicant: CUSHCORE, INC., Bend, OR (US)

(72) Inventor: Adam KREFTING, Bend, OR (US)

(21) Appl. No.: 17/685,933

(22) Filed: Mar. 3, 2022

Related U.S. Application Data
(60) Provisional application No. 63/155,800, filed on Mar. 3, 2021.

(51) Int. Cl. B60C 25/04

(52) U.S. Cl. CPC B60C 25/04; B60C 2200/12

(57) ABSTRACT

Apparatus and method for installing bicycle tires on rims, and removing the tires from the rims, both with and without tire inserts, is disclosed. The apparatus greatly eases the process of installing and removing a tire from a rim, especially a bicycle tire, and even more especially when a tire insert is used. The apparatus includes an axle that is received in and securely attached to the wheel's hub. A handle is pivotally attached to the axle and a tire removal and installation head is slidably located on the handle.

### RELATED APPLICATION

This application claims priority from U.S. Patent Application No. 63/155,800, filed Mar. 3, 2021, the entire disclosures of which is incorporated herein by reference.

### TECHNICAL FIELD

The present invention relates generally to tools used to install and remove pneumatic tires on rims, and more particularly to a tire installation and removal tool that is especially suited for installing a pneumatic bicycle tire, typically a tubeless pneumatic tire, on a rim, and removing the tire from the rim. The tool according to the invention may be used to install and remove any bicycle tire from a rim, including tires that utilize a tire insert.

### BACKGROUND OF THE INVENTION

Mounting a bicycle tire on a rim can sometimes be challenging. There are many variables that play into the difficulty of the process, including for instance the stiffness of the tire casing, the tire bead material, the dimensions of the tire and the rim, whether the tire is tubeless or tubed, and the installer's technique. Regardless of the particular situation, many cyclists are eventually able to acquire the skills necessary to successfully mount tires on their wheels, and this is important because as any cyclist knows, flat tires happen with some regularity and the cyclist is usually forced to repair the problem in the field.

Some types of tires are notoriously difficult to install on rims. For instance, tires that have stiff sidewall casings, such as tires specifically made for downhill mountain bike racing, can be difficult to install even for riders who have a lot of experience.

Recently, tire inserts for pneumatic bicycle tires such as those sold under the brand name CUSHCORE® have become very popular because they improve tire performance characteristics and increase reliability. CUSHCORE® tire inserts are protected by several US patents, including U.S. Pat. Nos. 10,286,736, 10,293,640, and 10,787,043, each of which is assigned to the assignee of the present application and the entire disclosures and contents of which are incorporated herein by this reference. While CUSHCORE® inserts provide substantial performance improvements, some cyclists find tire installation more difficult when inserts are installed. Numerous instructional videos posted online provide step by step guidance for easing the installation process, but there are also videos that discuss the difficulty of installing the inserts. As with bicycle tires that do not include inserts, cyclists eventually are able to install CUSHCORE® tire inserts on their bicycle rims without a struggle.

Given the difficulties that some users have experienced with installing tires on rims, adding to that the difficulties some users experience installing CUSHCORE® inserts, and taking into account the proven advantages CUSHCORE® inserts provide, there is a need for a tool that facilitates installation and removal of tires on rims, including where a tire insert will be installed with the tires. Moreover, bicycle manufacturers are beginning to offer CUSHCORE® inserts installed as original equipment (OEM) on the tires that are sold with new mountain bikes. This requires that the bicycle manufacturers install the tire inserts on many thousands of wheels, so there is an economic incentive to ease the installation of the tires with inserts on the wheels, and to increase the speed at which the tires with the inserts are mounted. Bicycle shops, mountain resorts, and rental fleets also mount many tires, so they need a tool that eases installation.

### SUMMARY OF THE INVENTION

The present invention defines a novel and unique apparatus and method for installing bicycle tires on rims and removing tires from rims, both with and without tire inserts. The invention is useful to cyclists, mechanics, and companies who desire a faster and easier way to mount and unmount tires with or without tire inserts.

The present disclosure features a tire installation and removal tool that greatly eases the process of installing and removing a tire (e.g., a bicycle tire) from a rim, especially when a tire insert is used. The tool comprises an axle that is received in and securely attached to the wheel's hub. A handle is pivotally attached to the axle and a tire removal and installation head is slidably located on the handle. One side of the tire removal and installation head is used to facilitate tire installation, and the opposite side of the tire removal and installation head is used to facilitate tire removal.

According to one embodiment, an apparatus for installing and removing a tire having tire beads on a wheel having a hub and a rim with a rim flange and a rim well comprises a hub attachment member for securing the apparatus to the wheel through the hub, a handle having a first end pivotally attached to the hub attachment member, and a head fixable at a desired position along the handle. The head includes a first side having one or more features configured to push the tire bead axially outward relative to the hub, and a second side having one or more features configured to push the tire bead into the rim well, wherein pivoting of the handle relative to the hub selectively positions the first side or the second side for interaction with the rim flange.

Some implementations of the apparatus include one or more of the following features.

In one example, the second side of the head includes a tire bead wheel configured to push the tire bead into the rim well, and the handle is mounted to be rotated by a user about the hub so that the wheel travels around the rim. In another example, the second side further includes a bead hook configured to hold the tool against the rim during rotation of the handle. The tire bead wheel may be rotatably mounted on the head and includes a frustoconical surface positioned for contact with the tire. In another example, the second side of the head further comprises a rim alignment tab disposed adjacent the tire bead wheel and configured to position the tool so that the tire bead wheel is slightly offset from the rim so that is does not generate friction by dragging on the rim.

In one example, the first side of the head includes a removal horn configured to guide the tire radially outward and around the rim flange. In another example, the first side of the head further includes a lever platform configured to assist a user with lifting the tire bead onto the removal horn using a tire lever.

In one example, the hub attachment member comprises an axle with first and second ends, the first end of the axle attached to the handle and a second end having an axle retainer thereon. The first end of the axle may include a conical hub seat, and the axle retainer may include a conical hub seat. In one example, the axle retainer is configured to be removably mounted on the second end to securely retain the axle within the hub.

In another example, the second side of the head includes a portion configured to support one of the tire beads away from the rim during installation of a tire insert into the rim.

In another example, a portion of the handle along which the head slides has a square cross-section. In one example, the head is fixed in position along the handle by a clamping mechanism comprising spring-biased clamping plates that apply a clamping force to the handle.

Further aspects and embodiments are directed to methods of installing tires on wheels and methods of removing tires from wheels. Some implementations of the methods may include one or more of the following features.

According to one embodiment, a method of installing a tire having first and second tire beads on a wheel having a hub and a rim with a rim flange and a rim well comprises mounting an apparatus on the wheel, the apparatus including a hub attachment device for securing the apparatus to the wheel through the hub, a handle pivotably mounted on the hub attachment device, and a head slidably mounted on the handle, the head including a first side having a tire bead wheel, and a bead hook; orienting and positioning the head with the first side facing the rim and tire; and inserting the first tire bead into the rim. The method further comprises positioning a portion of the second tire bead under the rim flange and positioning the apparatus with the tire bead wheel beyond the rim flange and the bead hook between the rim and the tire, and rotating the handle to cause the tire bead wheel to rotate and press the second tire bead into the rim.

In one example, the head further includes a rim alignment tab and orienting and positioning includes positioning the head such that the rim alignment tab is in contact with the rim.

In another example, positioning the head includes sliding the head along the handle.

The method may further comprise using the apparatus to insert a tire insert into an interior of the tire, prior to positioning the portion of the second tire bead under the rim flange. In one example, wherein the tire wheel has a frustoconical surface and inserting the tire insert includes rotating the apparatus around a circumference of the rim such that a main body of the head pushes the insert radially outward past the rim flange and the frustoconical surface presses the tire insert over the rim flange and into the interior of the tire.

The method may further comprise seating the tire bead hook under the bead such that the tire bead hook holds the tool down during the rotating step.

Another embodiment is directed to a method of removing a tire having tire beads from a wheel having a hub and a rim with a rim flange and a rim well. The method comprises mounting an apparatus on the wheel, the apparatus including a hub attachment device for securing the apparatus to the wheel through the hub, a handle pivotably mounted on the hub attachment device, and a head slidably mounted on the handle, the head having a first side including a tire bead wheel and a second side including a lever platform and tire removal horn, and positioning the apparatus with the first side of the head contacting a first side of the rim and using the tire bead wheel to unseat a first tire bead from the rim. The method further comprises pivoting the apparatus about the handle to position the second side of the head facing the tire with the lever platform contacting an outer surface of the rim, moving the tire bead away from the rim and onto the tire removal horn, and rotating the apparatus to cause the tire removal horn to lift the tire bead over the rim flange.

In one example, using the tire bead wheel to unseat the tire bead includes pressing down on the handle to press the tire bead wheel against the tire bead and rotating the handle around a circumference of the wheel to cause an outer surface of the tire bead wheel to apply pressure against a wall of the tire to unseat the tire bead and force the tire bead into the rim well.

The method may further comprise the steps of removing the apparatus from the wheel and re-mounting it with the first side of the head in contact with a second side of the rim and using the tire bead wheel to unseat a second bead of the tire to push the second bead into the rim well, prior to the pivoting step.

In one example, the method further comprises using a tire lever to lift the tire bead onto the removal horn by levering the tire lever against the lever platform.

Another embodiment is directed to a method of removing a first tire having tire beads from a wheel having a hub and a rim with a rim flange and a rim well and installing a second tire onto the wheel. The method comprises (a) removing the first tire by: mounting an apparatus on the wheel, the apparatus including a hub attachment device for securing the apparatus to the wheel through the hub, a handle pivotably mounted on the hub attachment device, and a head slidably mounted on the handle, the head having a first side including a tire bead wheel and a second side including a lever platform and tire removal horn, positioning the apparatus with the first side of the head contacting the rim and using the tire bead wheel to unseat a tire bead from the rim, then removing the apparatus from the wheel and re-mounting it with the first side of the head in contact with a second side of the rim and using the tire bead wheel to unseat a second bead of the tire to push the second bead into the rim well. Removing the first tire further includes pivoting the apparatus about the handle to position the second side of the head facing the tire with the lever platform contacting an outer surface of the rim, moving the tire bead away from the rim and onto the tire removal horn, rotating the apparatus to cause the tire removal horn to lift the tire bead over the rim flange, and removing the tire from the wheel. The method further comprises installing the second tire by: orienting and positioning the head with the first side facing the rim and tire and the rim alignment tab in contact with the rim, inserting the first tire bead into the rim, positioning a portion of the second tire bead under the rim flange and positioning the apparatus with the tire bead wheel beyond the rim flange and the bead hook between the rim and the tire, and rotating the handle to cause the tire bead wheel to rotate and press the second tire bead into the rim.

In certain examples, the method further comprises using the apparatus to insert a tire insert into an interior of the second tire. In one example, wherein the tire wheel has a frustoconical surface, inserting the tire insert includes rotating the apparatus around a circumference of the rim such that a main body of the head pushes the insert radially outward past the rim flange and the frustoconical surface presses the tire insert over the rim flange and into the interior of the second tire.

In certain examples, the first and second tires may be the same tire. For example, the apparatus can be used to remove a tire, which is then repaired and re-installed on the wheel according to the methods disclosed herein.

Various implementations of the methods may use embodiments of the apparatus disclosed herein, and various steps may be repeated as necessary to install and/or remove tires and/or tire inserts from the wheel.

Still other aspects, embodiments, and advantages of these exemplary aspects and embodiments are discussed in detail below. Embodiments and implementations disclosed herein may be combined with other embodiments and implementations in any manner consistent with at least one of the principles disclosed herein.

### BRIEF DESCRIPTION OF THE DRAWINGS

FIG. 1 is a perspective view of the tire installation and removal tool according to one implementation.

FIG. 1A is a perspective view of the tool shown in FIG. 1 taken from a different angle.

FIG. 2 is a cut-away perspective view of the tire installation and removal tool shown in FIG. 1, mounted on a rim in the orientation used to install the tire (and an insert if one is to be installed) on the rim.

FIG. 2A is an enlarged detail view showing the interaction of the tool with the rim in the orientation shown in FIG. 2.

FIG. 3 is a cut-away perspective view of the tire installation and removal tool shown in FIG. 1 with the handle flipped over such that the tool is mounted on a rim in the orientation used to remove the tire from the rim after the bead is broken.

FIG. 3A is an enlarged detail perspective view of the removal horn of the tool interacting with the rim.

FIG. 3B is a cut-away perspective view of the removal horn interacting with the rim.

FIG. 4 is cross-sectional view of the axle and axle retainer assembly and a portion of the handle installed in a wheel hub, with the rest of the wheel and tool omitted for clarity.

FIG. 5 is a perspective cross-sectional view of the axle retainer mounted on a lower portion of the axle.

FIG. 6 is a cross-sectional view of the tool taken along line 6-6 in FIG. 1.

FIG. 7 is an enlarged detail view of area A in FIG. 6.

FIG. 7A is an enlarged detail view of the clamping mechanism shown in FIG. 7.

FIG. 8 is a cut away perspective view of the tool head, showing the stabilizing set screws.

FIG. 8A is a planar view of FIG. 8.

FIG. 9 is a diagrammatic view in partial cross-section, showing a tire bead beginning to interact with the rim flange of a wheel rim.

FIG. 9A is similar to FIG. 9 but shows the tire bead wheel pushing the bead into the rim well of the rim.

FIG. 10 is a perspective view showing the interaction between the tire bead and the tool, with the remainder of the tire omitted for clarity.

FIG. 10A is a planar view of FIG. 10.

FIG. 11 is a perspective view showing the positioning of a tire lever against the lever platform of the tool.

FIG. 11A is a cross-sectional view showing the interaction of the tire lever and lever platform.

FIG. 12 is a cross-sectional view of a tire lever being inserted between a tire bead and the rim flange of a rim.

FIG. 12A shows the tire lever engaging the level platform to lift the bead over the rim flange.

FIG. 12B shows the bead resting on the removal horn, with the tire lever removed.

FIG. 13 is a perspective view showing an insert being inserted into the rim, with the tire omitted for clarity.

FIG. 13A is a side view showing the insert being inserted.

FIG. 14 is an alternative view of the insert being inserted.

FIG. 14A is similar to FIG. 14 but shows the tire bead wheel interacting with the insert.

FIG. 15 is a cross-sectional view of a tire and insert installed on a rim.

FIG. 16 is cross-sectional view of a tire loosely installed on a rim, with both beads outside of the rim.

FIG. 17A is a cross-sectional view of an insert being installed, with one bead of the tire in the rim and the other supported by a surface of the tool.

FIG. 17B is similar to FIG. 17A but shows the rim supported by a different location on the tool surface.

### DETAILED DESCRIPTION

One implementation of the tire installation and removal tool will now be described in detail with reference to the drawings. It will be understood that relative directional terms are used at times to describe components of the invention and relative positions of the parts. As a naming convention, the ground plane is considered to be a horizontal surface and relative directional terms correspond to this convention. With this convention, “upper” refers to the direction above and away from the ground plane; “lower” is generally in the opposite direction, “inward” is the direction from the exterior toward the interior of a component of the invention; for instance, the direction from the tire rim toward the tire hub is “inward.” “Vertical” is the direction normal to the horizontal ground plane, and so on.

Tool Structure

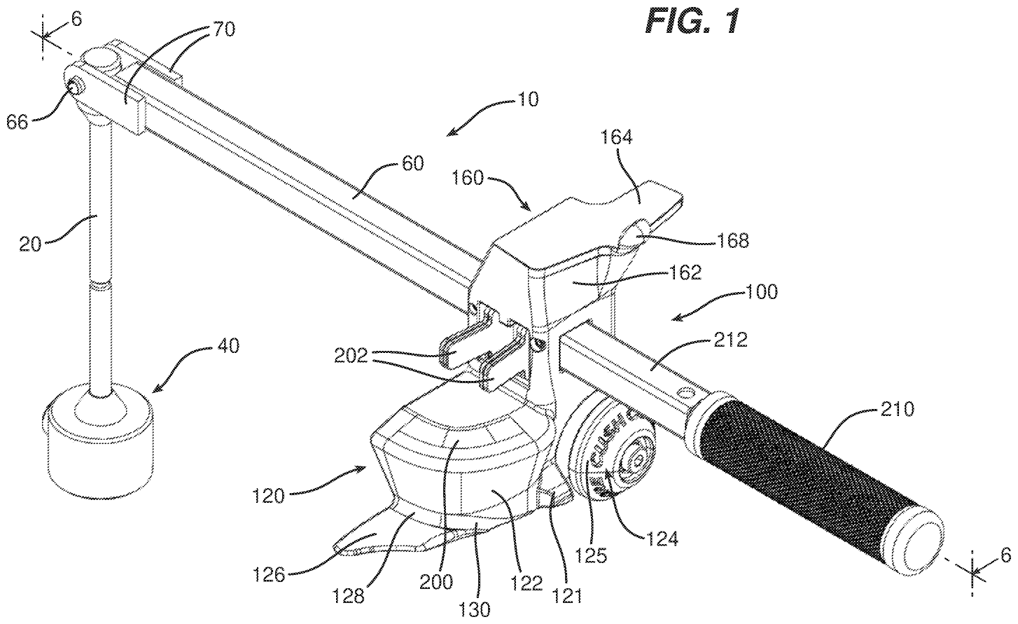

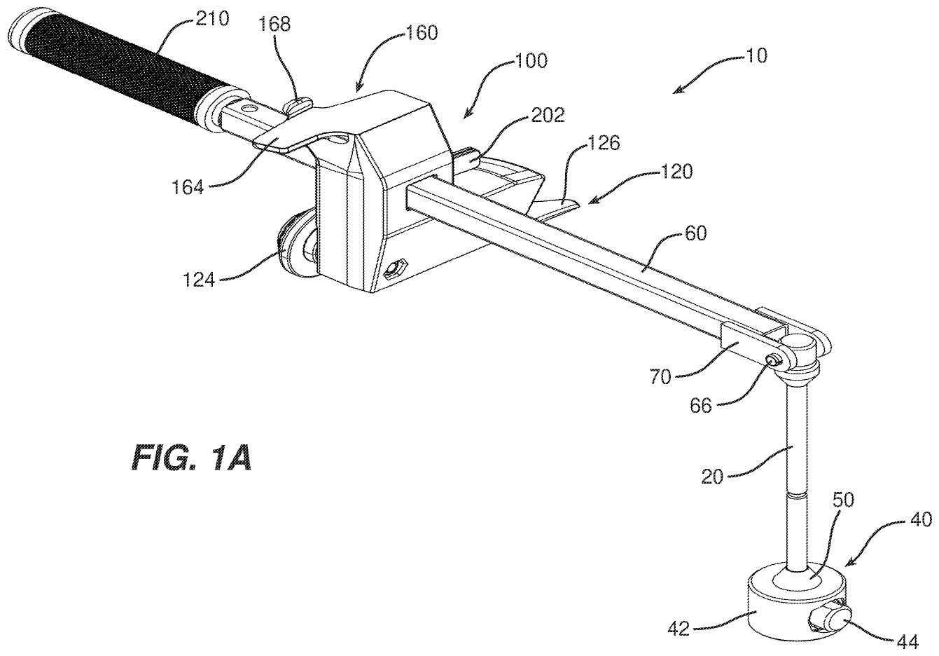

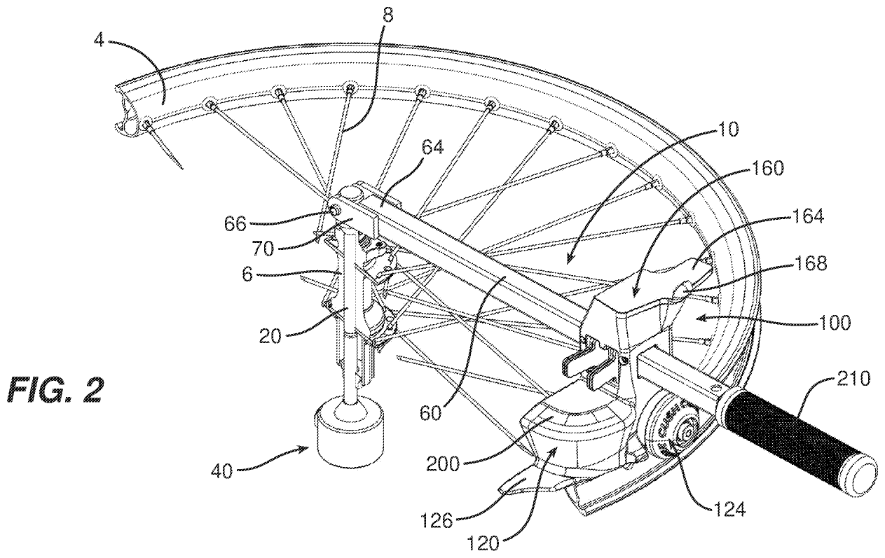

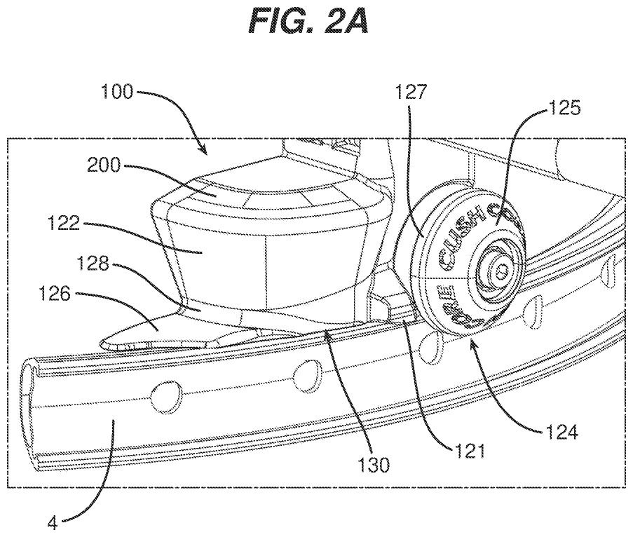

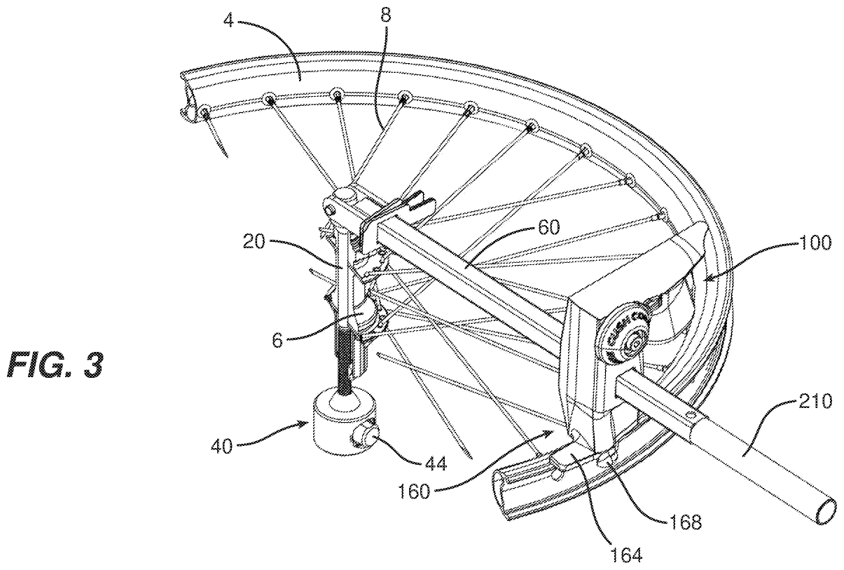

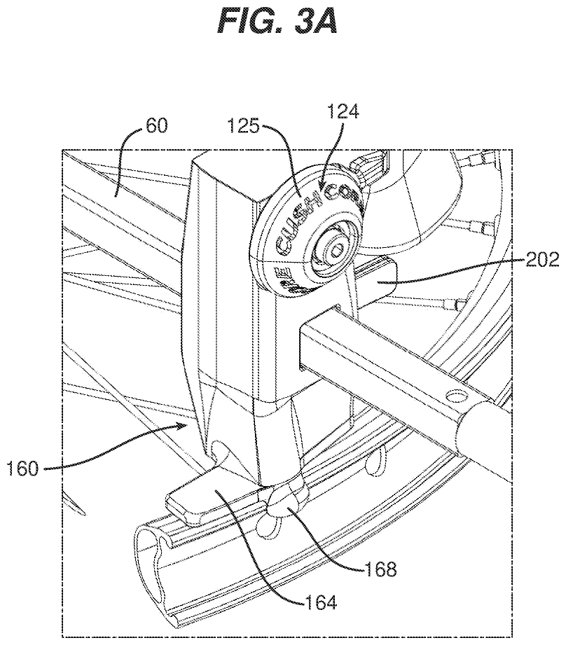

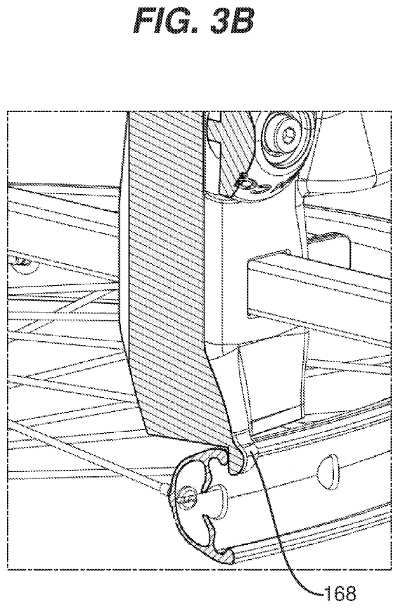

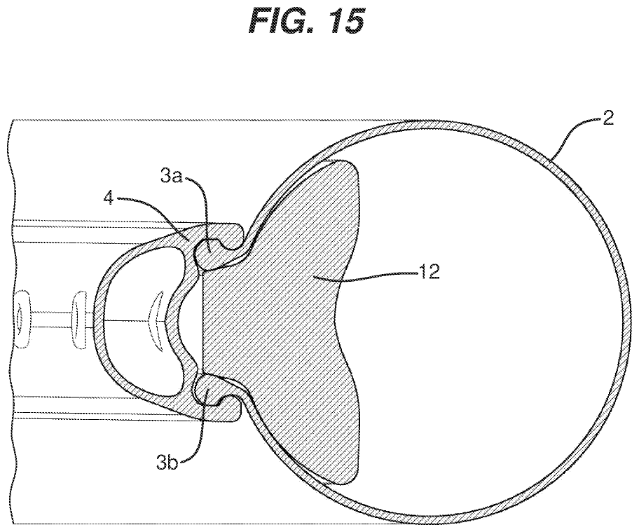

FIGS. 1 and 1A show a tire installation and removal tool 10 according to one implementation. Referring to FIG. 2, the tool 10 is used to install a bicycle tire 2 (FIG. 15) on a rim 4 of a wheel that is built up in a conventional manner with a hub 6 interconnected to the rim 4 with spokes 8. The hub is conventional and includes an axle through-hole that is normally used to mount the wheel on a bicycle. The tool 10 includes an axle 20 that is configured to be received through the through-hole in the hub to secure the tool 10 to the wheel, an axle retainer 40 that is mounted on axle 20 to retain the axle in the hub, a handle 60 pivotably mounted on the axle 20, and a tire installation and removal head 100. The tire installation and removal head 100 includes a first side 120 and a second side 160. The pivotal mounting of the handle allows the removal head to be easily flipped between a position in which the first side of the tool interacts with the rim (FIG. 2) and a position in which the second side of the tool interacts with the rim (FIG. 3).

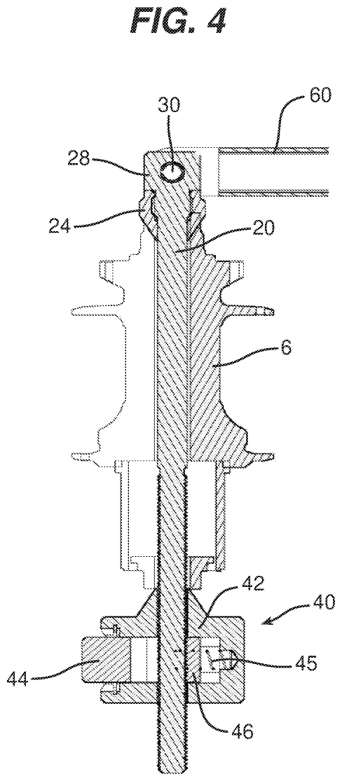

Referring to FIG. 4, axle 20 includes a rod that is at least partially threaded and is of sufficient length so that it may be inserted completely through the hub of the wheel (as shown in FIGS. 2 and 3) with enough threaded length remaining to attach the axle retainer 40 to the threaded portion of the axle and to allow the position of the axle retainer to be adjusted to accommodate different hub sizes. In the implementation shown, the axle 20 is only partially threaded, at the end to which the axle retainer is attached. If desired, in other implementations the axle may be threaded along its entire length. The threads are generally of a smaller diameter (e.g., 10 mm) than the smallest inner diameter (through-axle size, e.g., 12 mm) of the through-hole of the hub. This is to avoid contact between the threads and the hub so that insertion of the axle does not damage the hub finish. The proximal end of axle 20 has a frustoconical attachment 24 that nests in the hub when the axle is inserted into the through-hole of the hub. The frustoconical attachment 24 is a ring-shaped part that fits around the axle diameter. The frustoconical attachment 24 is fabricated from plastic, or a similar material that is softer than the material from which the hub is manufactured, to avoid damage to the hub. In some implementations the frustoconical attachment 24 may be designed so that it is threaded onto the axle. The frustroconical shape of the attachment 24 allows the axle to fit a wide range of bike hub inner diameters (e.g., 12-20 mm, common for mountain bike hubs).

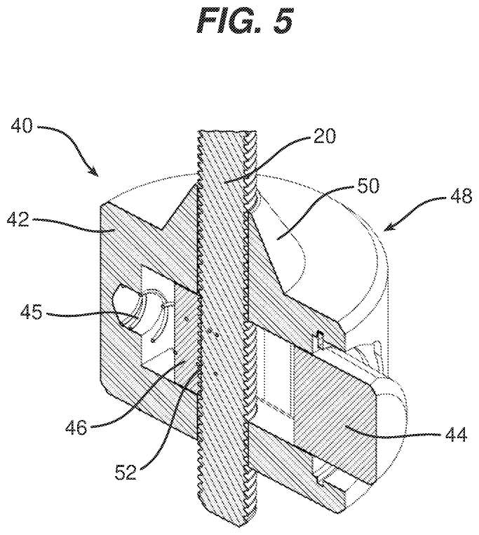

Turning to FIG. 5, the axle retainer 40 is a generally cylindrical member 42 with a central bore that receives the axle 20. It will be appreciated that the geometry of the axle retainer could be other than cylindrical. The axle retainer 40 includes a spring-loaded movable portion 46, an axle-facing surface of which is threaded at 52 and which defines the threaded portion of the otherwise-smooth central bore. A button 44 is pressed by the user to move the portion 46 away from the bore, allowing the axle retainer 40 to be slid onto the threaded end of the axle 20. When the button 44 is released the threads of the portion 46 immediately engage the threads of the rod due to the action of spring 45. The retainer may be removed from the rod by pushing the button to disengage the threads. This allows the axle retainer to be positioned on axle 20 very quickly by pressing the button and then the frustoconical extension 50 can be quickly secured to the hub bore by the user rotating the axle retainer sufficiently to tension the threads and lock the axle retainer to the hub. The axle retainer 40 is removed from the rod just as quickly. The user can rotate the axle retainer enough to remove the tension on the threads (e.g., about a ¼ turn or a ½ turn), and push the button 44 to disengage the threads and remove the axle retainer from the axle 20. The interior end 48 of axle retainer 40 defines the frustoconical extension 50 which nests in the bore through hub 6 when the axle 20 is installed in the wheel as shown in FIG. 4. The cylindrical member 42 has a relatively large diameter so that it is easy to grasp and manipulate, and which when threaded into position at the base of the hub very securely attaches the axle 20 to the hub 6.

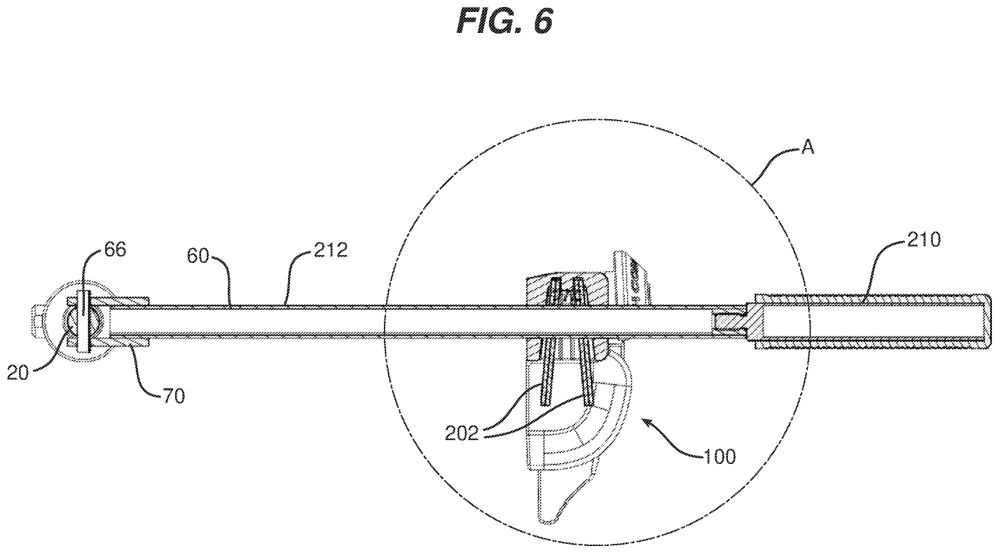

Immediately adjacent the frustoconical attachment 24 on axle 20 is a shaft section 28 with a cross hole 30 (FIG. 4). Referring to FIGS. 2 and 6, handle 60 is pivotally attached at its inboard end 64 to axle 20 with a pin 66 that extends through aligned bores in a yoke 70 and through the cross hole 30 of axle 20. In the implementation shown the pin 66 is a spring pin that expands to fill the concentric bores to eliminate undesirable movement in the pivot that could interfere with the ease of use of the head 100 and/or degrade the functionality of the tool.

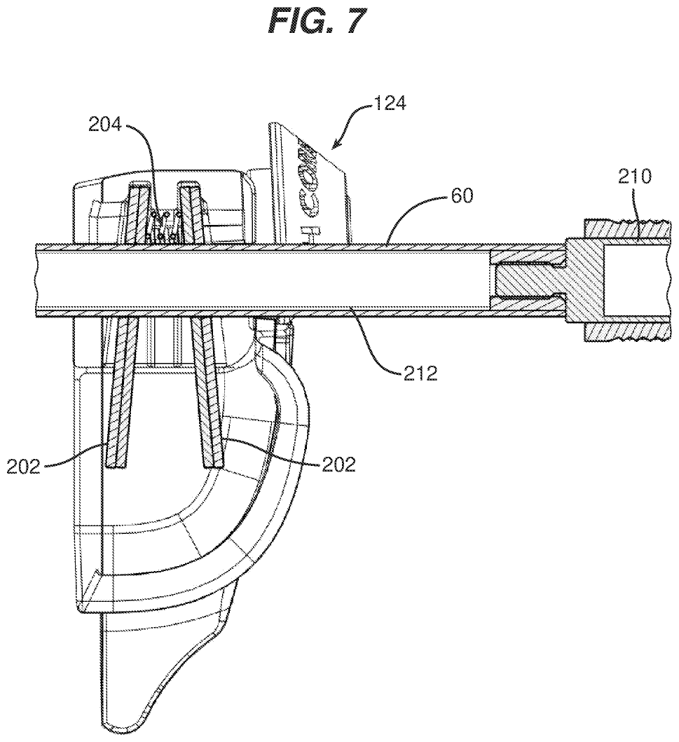

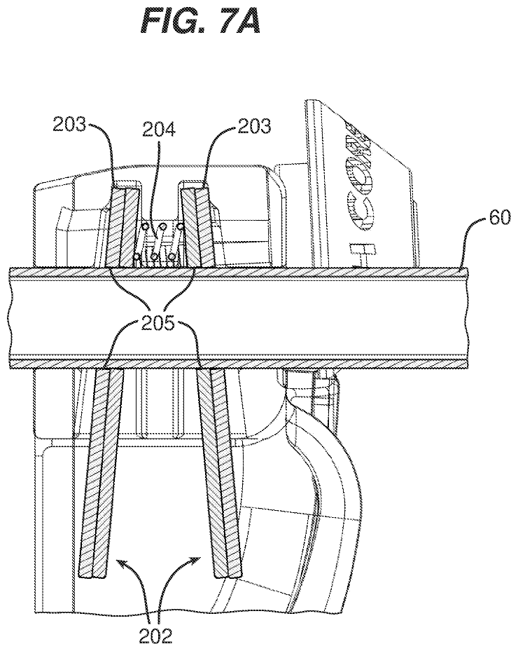

This pivotal attachment of handle 60 to axle 20 allows the handle 60 to be pivoted 180 degrees about the attachment, between the positions shown in FIGS. 2 and 3. The pivotal interconnection between the handle 60 and the axle 20 is important and controls the degrees of freedom in the handle. Specifically, the handle can only pivot around the axle in one axis of movement so that it controls the torque the tire applies to the tool head. The handle is preferably of a two-part construction, as shown in FIG. 6, allowing it to have a rectangular cross section along a major portion of its length (to facilitate the sliding attachment of head 100, described below) and a circular cross-section where the user grasps the handle, providing an ergonomic gripping portion 210. The gripping portion 210 is threaded into an end of the rectangular portion 212 as shown in FIG. 7. The handle is removable for assembly, storage, and transportation.

The tire removal and installation head 100 (referred to generally as head 100) is mounted on handle 60, as shown in FIG. 1. The head 100 is slidably mounted on handle 60 and may be fixed in any desired position on the handle (the position in which the head 100 contacts the rim). There are many different wheel sizes on the market, with the distance from the axial center of the hub 6 to the rim 4 being different for different wheel sizes. The ability to slide head 100 to the desired position on handle 60, and fix the head at that position, allows the tool 10 to be used with all adult bicycle wheel sizes. Referring to FIGS. 1, 7 and 7A, to accomplish this sliding adjustment the tool 1 includes a pair of clamping plates 202, which extend out of the head 100 as shown in FIG. 1. As shown in FIGS. 7 and 7A, the plates 202 include square bores through which the square portion of handle 60 extends. The plates 202 are biased towards the angled position shown in FIGS. 7 and 7A, in which distal edges of the plates press against the ends of a spring 204. In this locked position there is insufficient clearance between the square bores in the plates 202 and the outer surface of the handle for the plates to slide on the handle and the head is thus locked in place along the length of the handle. The angle of the plates (which may be about 5 degrees in certain examples) eliminates clearance with the handle in the locked position, and the fulcrum points 203 cause the edges 205 to clamp the handle in position. The spring 204 is confined side-to-side by the handle and pocket geometry shown in FIG. 7A. The plate pair shown on the left in FIG. 7A prevents the handle from sliding to the left, and the pair of plates on the right prevents the handle from sliding to the right. When the user presses the exposed parts of the plates together, against the spring force, this action causes the square bores in the plates to align, providing just enough clearance between the bores and the handle to slide the clamping plates (and thus the head 100) along the length of the handle. When the user releases the pressure, the spring 204 biases the plates 202 back to the angled position shown in FIGS. 7 and 7A, in which there is a clamping force generated between the bores in the plates and the handle due to the angle of the plates, as discussed above. If a force is applied to move the head without pressing the clamping plates together it just increases the angle of the plates, which increases the clamping force, and the clamping plates continue to hold the head firmly in place. Thus, the geometry provides a self-reinforcing clamping mechanism.

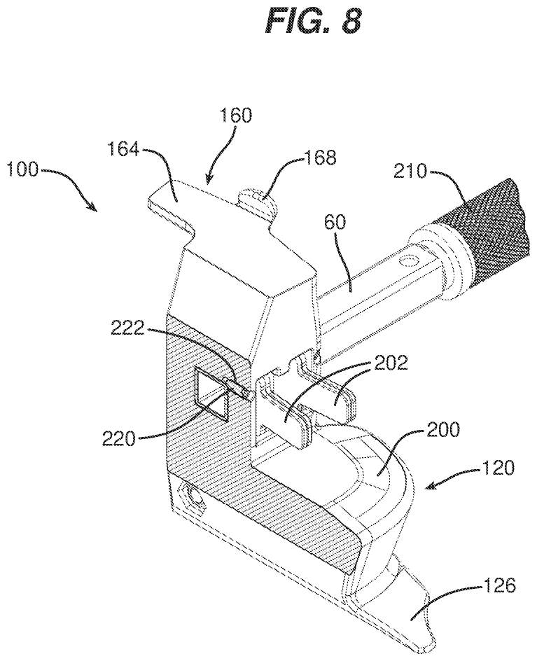

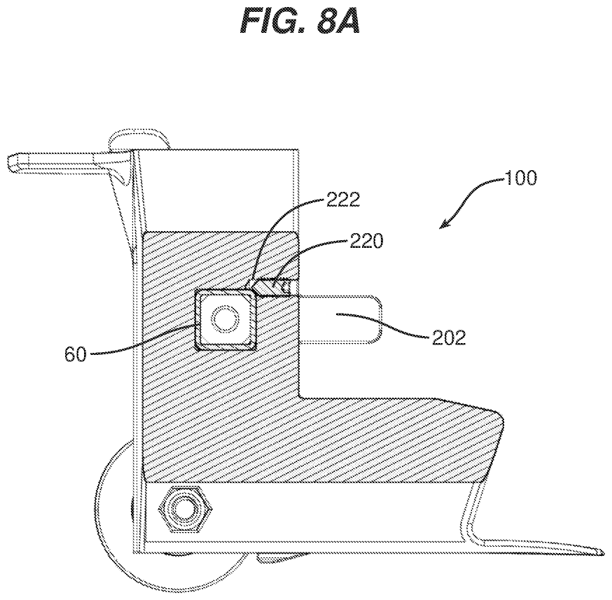

Referring now to FIGS. 8 and 8A, a pair of conical set screws 220 are provided on each lateral side of the clamping plates 202. Conical set screws are positioned in threaded bores 222 of the head 100, which are directly above the square bore through which the handle 60 passes. The user can adjust the set screws 220 against the adjacent corner of the handle 60, as shown in FIG. 8A, to remove excess rotational movement of the head 100 about the handle 60 during use, while still allowing the head 100 to slide along the handle 60 when the clamping plates 202 are depressed by the user.

Head 100 has two distinct sides, each with different operational functions, positioned on opposite sides of the head. The first side 120 of head 100 is used in the installation process and also used in an initial step of the removal process as will be described below. The second side 160 of head 100 is used in the removal process. It will be appreciated from review of the drawings that the tool 10 may be pivoted around the pin 66 so that either side of the head 100 may be presented to the rim, quickly enabling the functions unique to each side of the head 100. FIG. 2 shows an example of an orientation in which the first side 120 is presented to and operable on the rim 4, and FIG. 3 shows an example of an orientation in which the second side 160 is presented to and operable on the rim 4. The user can quickly switch the head 100 between the two orientations by pivoting the handle 60 about its pivotal attachment to axle 20 as described above.

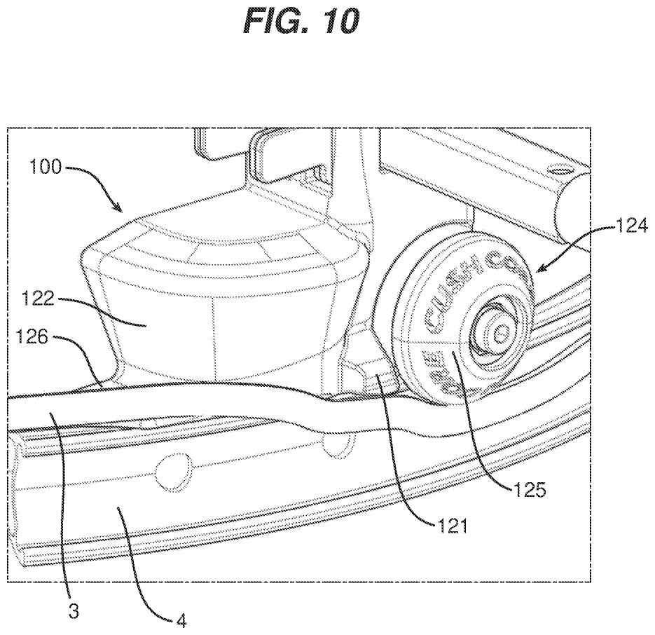

Referring to FIG. 1, FIG. 2A, and FIG. 10, the first side 120 of head 100 includes a main body 122 upon which is mounted a tire bead wheel 124, and which includes a bead hook 126. As will be described in further detail below, the main body 122 of the first side 120 forces the bead radially outward past the rim flange, then the wheel 124 presses the bead down below the flange into the rim, to properly seat the tire on the rim during installation. The generally plate-shaped bead hook 126 extends forwardly from the main body 122 and rides on the outer surface of the rim 4 during use. A bead guide 128 and a bead exit region 130 are located at the junction of the bead hook 126 and main body 122, as shown in FIG. 2A, the functions of which will be described below when tire installation is described in detail.

The second side 160 of head 100 includes a main body 162 that has a lever platform 164 that slides on the outer surface of the rim 4 during use, and a removal horn 168. As will be described below in detail in the Tire Removal section, the removal horn 168 is used during tire removal to retain the tire beads 3 and to guide them out and around the flange of the rim.

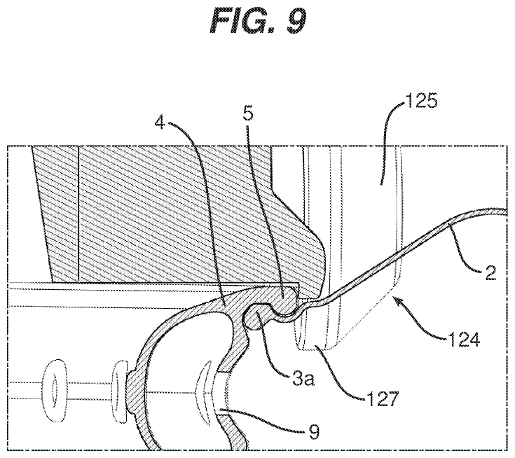

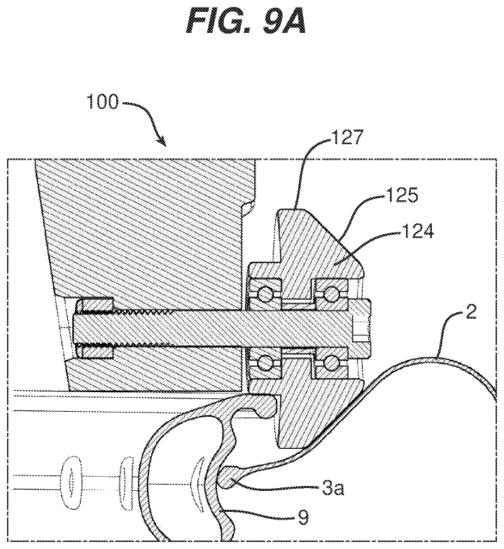

The tire bead wheel 124 is bolted to the head 100 as shown in FIG. 9A such that it can rotate during use. Wheel 124 has a frustoconical surface 125 that is configured to contact the tire bead 3 at the correct angle for installation/removal, and a flat circumferential side surface 127. The tire bead wheel 124 is positioned adjacent a rim alignment tab 121 that is used to align the head 100 to the rim when the head slides on the handle 60. The rim alignment tab 121 sets the tool in position to ensure that the tire bead wheel 124 is slightly offset from the rim 4 such that is does not generate friction by dragging on the rim.

The shape of the tire bead wheel 124 is configured based on requirements for different tasks for which the wheel is used to allow the wheel to function for all of these tasks. In early stages of a tire install (when the bead is not under tension), the circumferential side surface 127 and the frustoconical surface 125 press against the entire sidewall of the tire. A large contact area between the tire bead wheel 124 and the tire is desired at this stage because the tire is so loose on the wheel. If the tire bead wheel 124 were too narrow, the tire would not stay in position under the wheel and could not be guided into the rim 4. In later stages of a tire install (when the bead is under tension), a narrow tire bead wheel 124 better concentrates force directly on the tire bead. This reduces the force required to “drop the bead” into the rim well. At this stage, the bead is under enough tension that it can stay in position under a narrow wheel and most of the pressure comes from the circumferential side surface 127. In a first step in the removal process, which includes breaking the bead, a narrow tire bead wheel 124 would again be preferable for the same reasons as in the later stages of a tire install. The circumferential side surface 127 of the wheel 124 is primarily responsible for breaking the bead prior to tire removal. Thus, the width and shape of the tire bead wheel may be selected based on a compromise between the need for a narrower wheel in some circumstances, and a wide wheel in others. The frustoconical surface 125 is also used during an insert install to facilitate moving the insert from above the rim plane downward into the tire. The smaller diameter section of the wheel 124 is designed to roll on the rim 4. This reduces friction under load. The contact force between the head 100 and the rim 4 can be significant in two situations: (1) to break the bead, the user must apply downward pressure on the handle while rotating it, and (2) In the final stages of tire installation, the bead is positioned over the bead hook 126. As bead tension increases, it exerts more and more downward pressure on the bead hook 126, squeezing it (and the entire tool head) against the rim 4. While this pressure is a benefit, it does increase friction, which the wheel 124 reduces substantially.

Tire Installation

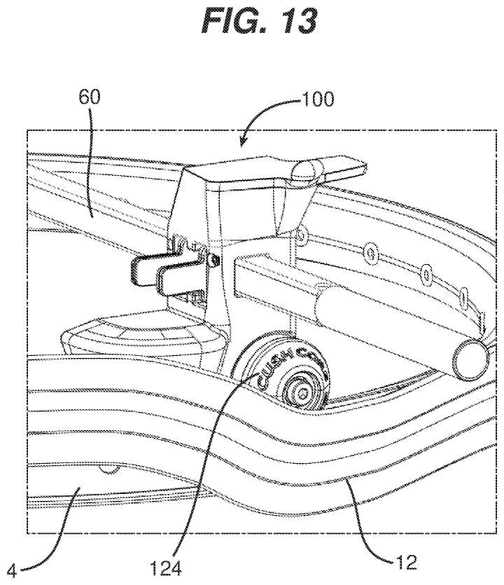

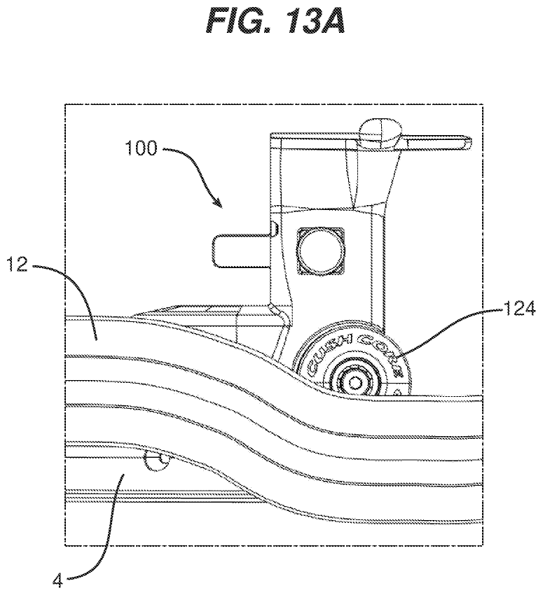

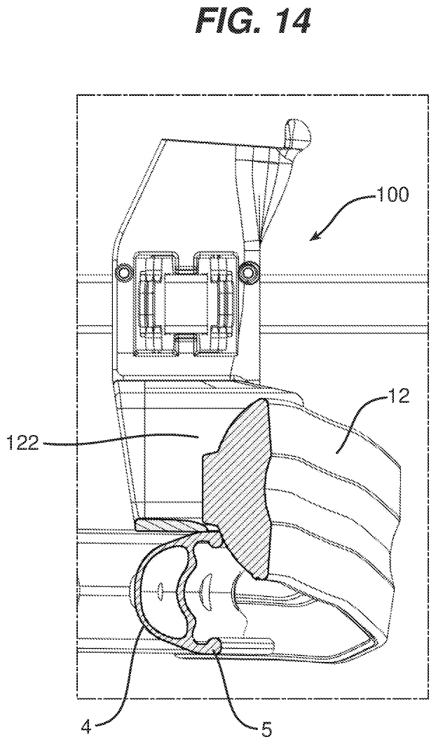

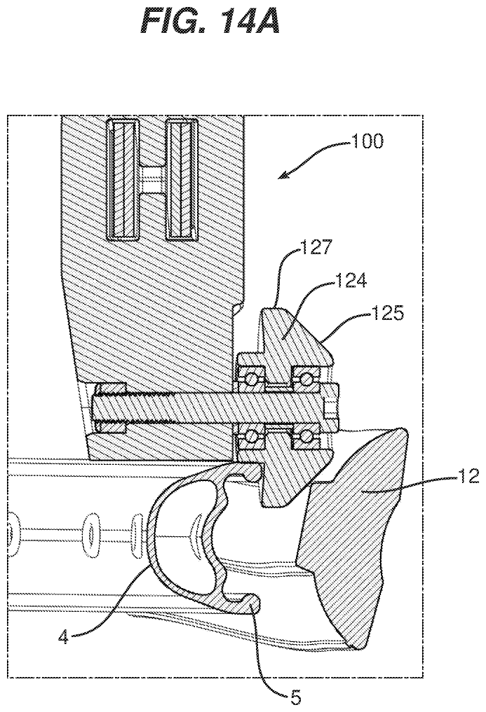

The process for installing a tire insert 12 and a tire 2 on a rim will now be explained with reference to FIGS. 9-10A and 13-15. It is noted that in FIGS. 13-14A, showing insert installation, the tire is omitted for clarity. Some steps, which will be clear to the reader without illustration, are not shown in the drawings.

Initially, the tire 2 is loosely assembled with the rim 4 such that the tire is around the rim, but both beads 3a, 3b are outside the rim 4 (as shown in FIG. 16). A next step is to install the first bead 3a. After this step, one bead 3a of the tire is over the rim flange 5 (FIG. 9) of the rim. This step can generally be done by hand, e.g., using a tire lever in a conventional manner, or may be done using the tool according to the method described below. If a tire insert 12 is to be installed, a portion of the insert 12 (about 50%) is then loosely inserted by hand into the tire interior (FIG. 15). If desired, the interior of the tire casing may be lubricated to reduce friction between the insert and tire casing during installation (for example, by spraying soapy water into the tire).

The tool 10 is attached to the wheel assembly (i.e., hub 6, rim 4, spokes 8) by threading the axle 20 through the through-hole of the hub 6 and securing the axle retainer 40 to the distal end of the axle. The tool and wheel are then set on a good support (for example, the open end of a garbage can or other receptacle). The user pivots handle 60 so that the first side 120 is facing the rim and tire, as shown in FIG. 2, and presses clamping plates 202 together to slide the head 100 along the handle 60 to a point at which the rim alignment tab 121 contacts the rim 4 and the head 100 is aligned with the rim 4. The user then releases the clamping plates 202 so that the head 100 is fixed at the desired position on handle 60 to accommodate the diameter of the wheel upon which the tire is being mounted.

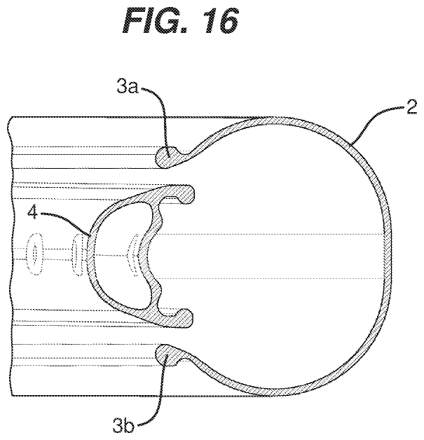

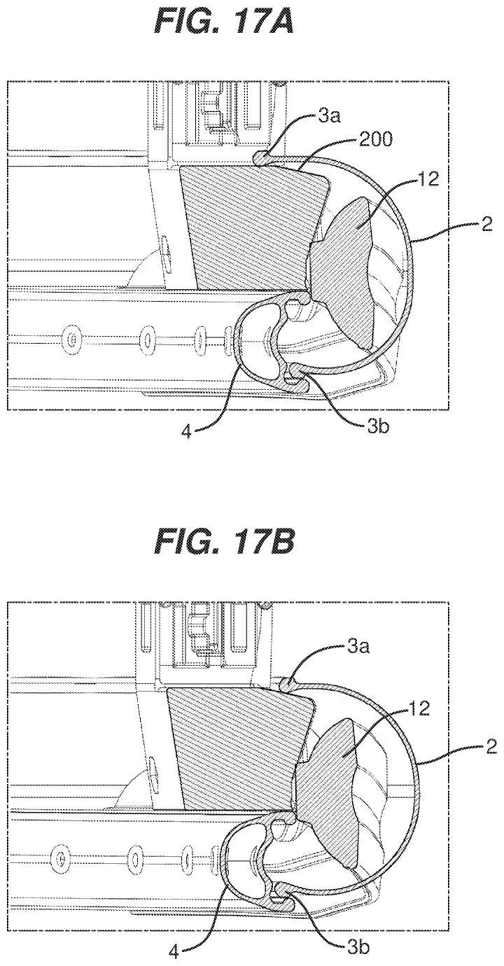

With the installation tool 10 adjacent to the tire 2 and the insert 12 under light tension, the user positions the tire bead 3a such that the bead is draped over surface 200 (FIG. 1) of the head 100. As shown in FIGS. 17A and 17B, surface 200 holds the tire clear of the insert 12 so it does not interfere with installation. This also ensures the force exerted by the tool is directed into the insert rather than into the tire. If desired, the tire bead can be lubricated before or during insertion (e.g., with soapy water).

Next, the tool is rotated around the circumference of the rim. Referring to FIGS. 14 and 14A, the main body 122 of head 100 pushes the insert 12 radially outwardly past the rim flange 5, and the frustoconical surface 125 of the wheel 124 presses the insert over the rim flange 5 so that it is moving into the seated position. After a full rotation of tool 10 around the wheel, the insert 12 is fully inserted into the tire interior.

The second bead 3b of tire 2 is now ready for seating on the rim 4. The user first manually rolls the tire sidewall outward so that a small portion of the bead 3b may be inserted under the rim flange by the user. The tool head 100 is placed on the rim 4 where the tire bead 3b has been inserted into the rim. Tool 10 remains in the position along the handle in which it was previously set and locked (the correct position for the wheel diameter), such that it is now positioned with wheel 124 just beyond the rim flange 5 of rim 4 and the bead hook 126 positioned between the rim and the tire. The user presses handle 60 downwardly and begins rotating the handle as the wheel 124 presses tire bead 3b over the rim flange 5. The bead hook 126 helps hold the head 100 down onto the rim flange, due to tension exerted by the tire bead. During the initial part of installation, when the bead is not under tension, it may be necessary for the user to press the tool downward onto the rim face. As discussed above, at this stage the frustoconical surface 125 is used to apply pressure to the bead. As installation progresses, tension on the tire bead increases. This tension exerts a downward force on the bead hook 126, holding the tool against the rim face with little or no downward force required from the user. At this stage most of the pressure comes from the side surface 127 of the wheel 124, rather than from the frustoconical surface 125.

The user continues to rotate handle 60 around the wheel. As the handle rotates, the tire bead 3 is pressed radially outward by the main body 122 of first side 120 of the head 100, guided by the bead guide 128 of the edge of the bead hook 126. This is shown diagrammatically in FIGS. 10 and 10A, in which only the bead 3 of the tire is shown for clarity. FIGS. 10 and 10A show the position of the tire bead 3 when the bead is almost fully installed (e.g., about 90% installed). Earlier in the installation process, the bead 3 wraps around more of the bead guide 128 than is shown in FIGS. 10 and 10A. The bead guide 128 pushes the bead radially outward such that the bead is extending over rim flange 5 (FIG. 9). As rotation of tool 10 continues, the bead separates from the tool body at bead exit region 130 of the bead hook 126 and wheel 124 presses the bead further inward into the rim well 9 (in the lateral center of the rim) as shown in FIGS. 9A and 10A. The bead can then move into a seated position. The bead 3 is seated on the “bead seat” when the tire 2 is inflated—the air pressure from inflation of the tire pops the bead 3 into position. Note that the tire is inflated after the installation process is complete. In certain instances, the tire is installed and seated on the rim with one complete rotation of tool 10 around the wheel. In other instances, the bead 3 may require more help into the rim well 9. In such instances, the user may reverse the rotation direction of the tire bead wheel 124 to counter-clockwise and backtrack across the installed portion of the bead 3, applying downward pressure so that the tire bead wheel 124 forces the bead 3 into the rim well 9. Once the installed portion of the bead 3 is fully in the rim well 9, the user may once again rotate the wheel 124 in the clockwise direction and complete installation of the tire.

Tire Removal

Use of the tool 10 to remove a tire 2 (and optionally a tire insert, if used) from a rim 4 will be explained with reference to FIGS. 3A, 3B and 11-12B.

Tool 10 is first attached to the built-up wheel. Thus, the operational axle for the wheel is removed and axle 20 is inserted through the axle opening in the hub 6 and the axle retainer is slid onto the shaft of axle 20 and positioned tightly against the hub. As noted above, the frustoconical attachment 24 on one end of axle 20 in combination with the frustoconical extension 50 on the axle retainer serve to retain the tool firmly in position in the hub.

The user places the wheel horizontally on a good working support. The user slides head 100 along handle 60 as described above and adjusts the position of the head so that the head is aligned with the rim, in this case with the removal horn contacting the rim, and releases the clamping plates to fix the head in place. FIGS. 3A and 3B show detailed views of an example of the removal horn interacting with the rim.

First, the tool is positioned with the first side 120 contacting the rim, as shown in FIG. 2. This allows the wheel 124 to be used to “break the bead”, unseating the tire bead from its seated position on the rim. The user does this by pressing down on the handle so that wheel 124 is pressing against the bead while rotating the handle around the circumference of the wheel. The side surface 127 of the wheel 124 is configured to apply sufficient pressure against the tire wall to break the bead. As the wheel 124 pressed down on the bead 3a, the interconnection between the bead and the rim seat is broken very effectively, forcing the bead off the bead seat 11 and all the way into the rim well 9.

The rim well 9 has a smaller diameter than the bead seat 11, so pushing the bead into the rim well gives the user additional slack, i.e., to grab the bead 3a with a tire lever 230 as detailed below. The bead 3a has a fixed diameter with only very minimal ability to stretch. The bead seat 11 is about the same diameter as the tire bead, so when the tire bead 3a is on the bead seat 11 the tire is fixed in position. When the bead 3a is forced into the smaller diameter rim well 11 the tire can move slightly laterally relative to the rim. This allows the installer to manipulate the bead over the rim flange 5.

The user can then flip the wheel over, reinstall the tool 10, and use the wheel to break the bead on the other side of the tire.

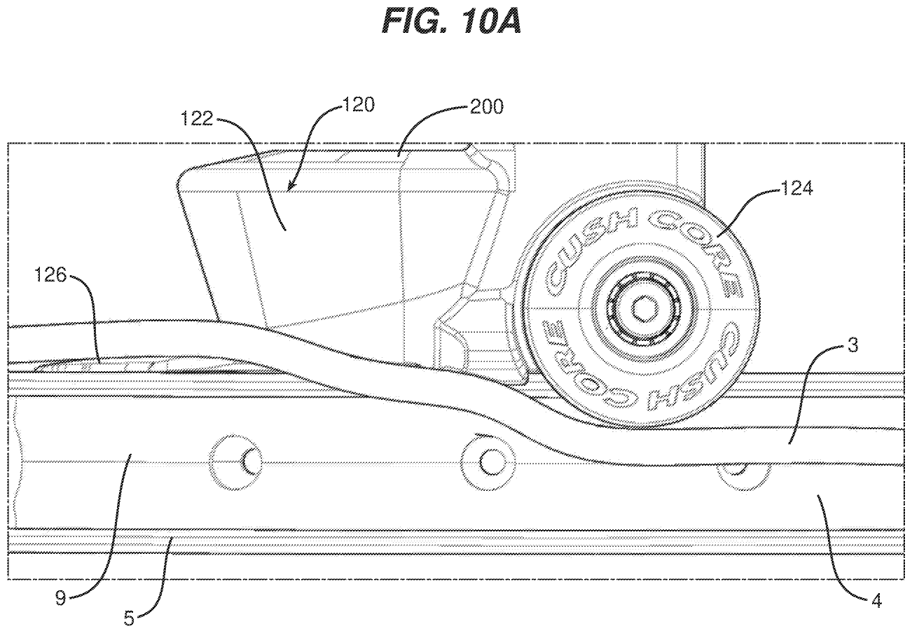

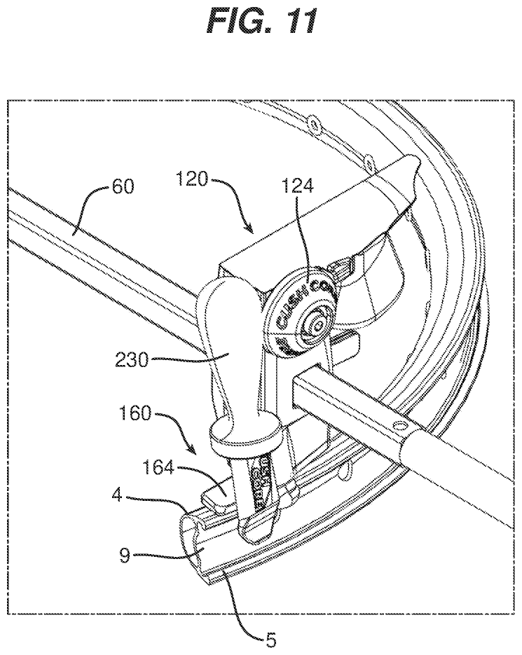

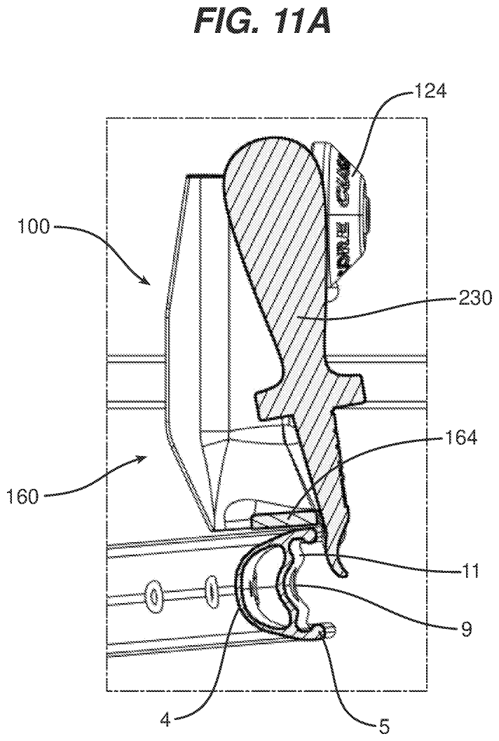

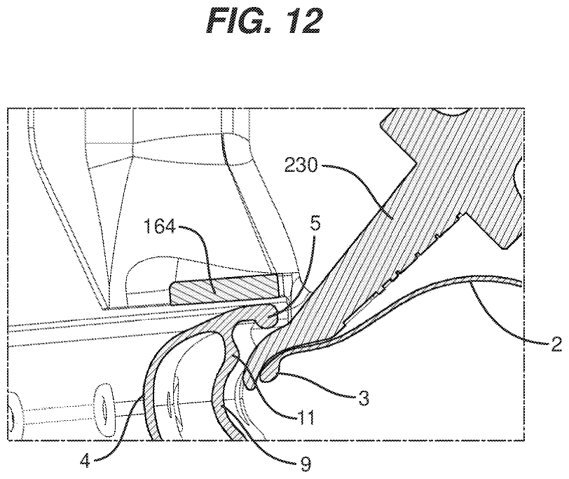

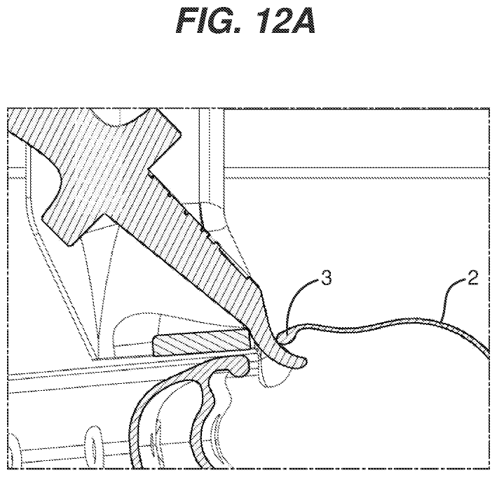

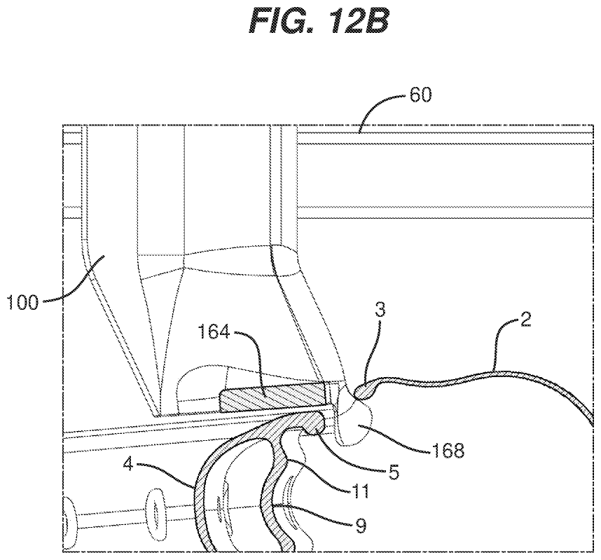

The tool 10 is then pivoted 180 degrees so that the second side 160 of the head 100 is facing the tire 2, as shown in FIG. 3. In this position the lever platform 164 on the second side 160 of the head 100 is lying on the outer surface of rim 4. A conventional tire lever 230 is used to pry off one section of the bead 3a from the rim 4. The tire lever 230 is positioned in front of the lever platform 164 and adjacent to the removal horn (FIG. 11A), which changes the fulcrum of the tire lever 230, enabling the tire bead to be installed onto the removal horn 168 (FIG. 12A). Using the tire lever, the user pries bead 3a away from the rim and upward until bead 3a rests on removal horn 168.

The tool 10 is then rotated, and as rotation continues the removal horn 168 separates the bead 3a from the seated position in rim 4 and lifts the bead over the rim flange 5 to demount the bead. The removal horn is shaped to move the bead in a circular path up and over the rim flange 5 to reduce friction and minimize the risk of tire damage caused by contact between the bead and the potentially sharp rim flange during removal.

At this stage, the other bead 3b of the tire is still installed. To remove the other bead 3b, the user removes the axle, flips the wheel over and re-installs the axle. The user then repeats the removal process using the tool on the second bead 3b. The insert and tire are now loose and can be removed from the wheel by hand.

The tool greatly simplifies the process of installing tires on rims and speeds up the process. While the tool 10 is especially designed for use with tires that will include an insert 12, the tool works equally well with tires that do not include an insert.

### OTHER EMBODIMENTS

While the present invention has been described in terms of preferred and illustrated embodiments, it will be appreciated by those of ordinary skill that the spirit and scope of the invention is not limited to those embodiments but extend to the various modifications and equivalents as defined in the appended claims.

For example, in addition to the yoke connection of the handle to the axle described above, there are numerous other means possible to connect the handle to the axle while restricting movement to the desired axis. Moreover, the handle may be a single part, rather than the two-part construction described above, and may be rectangular, cylindrical, or any desired combination of geometries.

Moreover, while the first side and second side are typically part of a single integrally molded head 100, as shown and described above, if desired they may be molded as separate parts and interconnected with appropriate fasteners to form an assembled head.

Additionally, instead of angled surface 200 of the first side 120 of the head 100 it will be appreciated that other types of “hangers” may be used to hold up the tire, for example a molded protrusion extending from the main body 122 of first side 120.

Having described above various aspects and examples of at least one embodiment, it is to be appreciated various alterations, modifications, and improvements will readily occur to those skilled in the art. Such alterations, modifications, and improvements are intended to be part of this disclosure and are intended to be within the scope of the invention. It is to be appreciated that embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Accordingly, the foregoing description and drawings are by way of example only.

What is claimed is:

1. Apparatus for installing and removing a tire having tire beads on a wheel having a hub and a rim with a rim flange and a rim well, the apparatus comprising:
a hub attachment member for securing the apparatus to the wheel through the hub;
a handle having a first end pivotally attached to the hub attachment member; and
a head fixable at a desired position along the handle, the head including a first side having one or more features configured to push the tire bead axially outward relative to the hub, and a second side having one or more features configured to push the tire bead into the rim well, wherein pivoting of the handle relative to the hub selectively positions the first side or the second side for interaction with the rim flange.

2. The apparatus of claim 1 wherein the second side includes a tire bead wheel configured to push the tire bead into the rim well and the handle is mounted to be rotated by a user about the hub so that the wheel travels around the rim.

3. The apparatus of claim 2 wherein the second side further includes a bead hook configured to hold the tool against the rim during rotation of the handle.

4. The apparatus of claim 2 wherein the tire bead wheel is rotatably mounted on the head and includes a frustoconical surface positioned for contact with the tire.

5. The apparatus of claim 2 wherein the second side further comprises a rim alignment tab, disposed adjacent the tire bead wheel, configured to position the tool so that the tire bead wheel is slightly offset from the rim so that is does not generate friction by dragging on the rim.

6. The apparatus of claim 1 wherein the first side includes a removal horn configured to guide the tire radially outward and around the rim flange.

7. The apparatus of claim 6 wherein the first side further includes a lever platform configured to assist a user with lifting the tire bead onto the removal horn using a tire lever.

8. The apparatus of claim 1 wherein the hub attachment member comprises an axle with first and second ends, the first end of the axle attached to the handle and a second end having an axle retainer thereon.

9. The apparatus of claim 8 wherein the first end of the axle includes a conical hub seat, and the axle retainer includes a conical hub seat.

10. The apparatus of claim 8 wherein the axle retainer is configured to be removably mounted on the second end to securely retain the axle within the hub.

11. The apparatus of claim 1 wherein the second side includes a portion configured to support one of the tire beads away from the rim during installation of a tire insert into the rim.

12. The apparatus of claim 1 wherein a portion of the handle along which the head slides has a square cross-section.

13. The apparatus of claim 11 wherein the head is fixed in position along the handle by a clamping mechanism comprising spring-biased clamping plates that apply a clamping force to the handle.

14. A method of installing a tire having first and second tire beads on a wheel having a hub and a rim with a rim flange and a rim well, the method comprising:
mounting an apparatus on the wheel, the apparatus including a hub attachment device for securing the apparatus to the wheel through the hub, a handle pivotably mounted on the hub attachment device, and a head slidably mounted on the handle, the head including a first side having a tire bead wheel, and a bead hook;
orienting and positioning the head with the first side facing the rim and tire;
inserting the first tire bead into the rim;
positioning a portion of the second tire bead under the rim flange and positioning the apparatus with the tire bead wheel beyond the rim flange and the bead hook between the rim and the tire; and
rotating the handle to cause the tire bead wheel to rotate and press the second tire bead into the rim.

15. The method of claim 14 wherein the head further includes a rim alignment tab and orienting and positioning includes positioning the head such that the rim alignment tab is in contact with the rim.

16. The method of claim 14 wherein positioning the head includes sliding the head along the handle.

17. The method of claim 14 further comprising using the apparatus to insert a tire insert into an interior of the tire, prior to positioning the portion of the second tire bead under the rim flange.

18. The method of claim 17 wherein the tire wheel has a frustoconical surface and wherein inserting the tire insert includes rotating the apparatus around a circumference of the rim such that a main body of the head pushes the insert radially outward past the rim flange and the frustoconical surface presses the tire insert over the rim flange and into the interior of the tire.

19. The method of claim 14 further comprising seating the tire bead hook under the bead such that the tire bead hook holds the tool down during the rotating step.

20. A method of removing a tire having tire beads from a wheel having a hub and a rim with a rim flange and a rim well, the method comprising:
mounting an apparatus on the wheel, the apparatus including a hub attachment device for securing the apparatus to the wheel through the hub, a handle pivotably mounted on the hub attachment device, and a head slidably mounted on the handle, the head having a first side including a tire bead wheel and a second side including a lever platform and tire removal horn;
positioning the apparatus with the first side of the head contacting a first side of the rim and using the tire bead wheel to unseat a first tire bead from the rim;
pivoting the apparatus about the handle to position the second side of the head facing the tire with the lever platform contacting an outer surface of the rim;
moving the tire bead away from the rim and onto the tire removal horn; and
rotating the apparatus to cause the tire removal horn to lift the tire bead over the rim flange.

21. The method of claim 20 wherein using the tire bead wheel to unseat the tire bead includes pressing down on the handle to press the tire bead wheel against the tire bead and rotating the handle around a circumference of the wheel to cause an outer surface of the tire bead wheel to apply pressure against a wall of the tire to unseat the tire bead and force the tire bead into the rim well.

22. The method of claim 21 further comprising the steps of removing the apparatus from the wheel and re-mounting it with the first side of the head in contact with a second side of the rim and using the tire bead wheel to unseat a second bead of the tire to push the second bead into the rim well, prior to the pivoting step.

23. The method of claim 20 further comprising using a tire lever to lift the tire bead onto the removal horn by levering the tire lever against the lever platform.

24. A method of removing a first tire having tire beads from a wheel having a hub and a rim with a rim flange and a rim well and installing a second tire onto the wheel, the method comprising:
(a) removing the first tire by:
mounting an apparatus on the wheel, the apparatus including a hub attachment device for securing the apparatus to the wheel through the hub, a handle pivotably mounted on the hub attachment device, and a head slidably mounted on the handle, the head having a first side including a tire bead wheel and a second side including a lever platform and tire removal horn;
positioning the apparatus with the first side of the head contacting the rim and using the tire bead wheel to unseat a tire bead from the rim;
removing the apparatus from the wheel and re-mounting it with the first side of the head in contact with a second side of the rim and using the tire bead wheel to unseat a second bead of the tire to push the second bead into the rim well
pivoting the apparatus about the handle to position the second side of the head facing the tire with the lever platform contacting an outer surface of the rim;
moving the tire bead away from the rim and onto the tire removal horn; and
rotating the apparatus to cause the tire removal horn to lift the tire bead over the rim flange; and
removing the tire from the wheel; and
(b) installing the second tire by:
orienting and positioning the head with the first side facing the rim and tire and the rim alignment tab in contact with the rim;
inserting the first tire bead into the rim;
positioning a portion of the second tire bead under the rim flange and positioning the apparatus with the tire bead wheel beyond the rim flange and the bead hook between the rim and the tire; and
rotating the handle to cause the tire bead wheel to rotate and press the second tire bead into the rim.
